(19) United States
(12) Patent Application Publication
(10) Pub. No.: US 2021/0345077 A1
(43) Pub. Date: Nov. 4, 2021

(54) eUICC PROVISIONING FOR AUTONOMOUS DEVICES

(71) Applicant: Telefonaktiebolaget LM Ericsson (publ), Stockholm (SE)

(72) Inventors: Beatriz GRAFULLA-GONZÁLEZ, Solna (SE); Jinhua FENG, Täby (SE); Morgan LINDQVIST, Sundbyberg (SE); Rémi ROBERT, Solna (SE)

(73) Assignee: Telefonaktiebolaget LM Ericsson (publ), Stockholm (SE)

(21) Appl. No.: 17/281,976

(22) PCT Filed: Oct. 5, 2018
(86) PCT No.: PCT/SE2018/051026

§ 371 Date: Mar. 31, 2021

(51) Int. Cl. H04W 4/50; H04W 8/20

(52) U.S. Cl. CPC H04W 4/50; H04W 8/205

(57) ABSTRACT

An embedded Universal Integrated Circuit Card (eUICC) for a device and an entity configured to perform the method. The method further relates to eUICC profile provisioning of a device and an entity configured to perform the method. The method further provides for a device manufacturer of registering an eUICC for a device. The method comprises registering an eUICC identifier and a device identifier with a registering authority being responsible for registering ownership of the device, wherein an owner of the device subsequently registers ownership of the device by providing the device identifier to the registering authority along with an owner identifier.

### TECHNICAL FIELD

The invention relates to a method of registering an embedded Universal Integrated Circuit Card (eUICC) for a device, and an entity configured to perform the method. The invention further relates to a method of eUICC profile provisioning of a device, and an entity configured to perform the method.

### BACKGROUND

Autonomous vehicles such as autonomous cars and unmanned aerial vehicles (UAVs), also named drones, are cars/aircrafts without a human driver/pilot aboard. Due to the potential danger that such vehicles represent, many countries aim at enforcing registration of every vehicle by the owner. This process links the autonomous vehicles with at least one person that can be held responsible in case of accident.

In the future, it is expected that many self-driving cars and drones will need to be connected to a mobile network (first 4G and then 5G) to carry out their task. This connectivity will be utilized for transporting control signalling required for controlling the vehicle as well as for transferring payload application data.

Historically, every cellular device, such as a mobile phone, smartphone, or any other mobile terminal which is configured for communicating over a cellular radio access network, such as Global System for Mobile Communications (GSM), Universal Mobile Telecommunications System (UMTS), or Long-Term Evolution (LTE), has been equipped with a removable Universal Integrated Circuit Card (UICC). The UICC is a smart card defined in ETSI TR 102 216. It typically contains a number of applications, in particular the Subscriber Identity Module (SIM) application for use in GSM networks and the Universal SIM (USIM) for use in UMTS and LTE networks. The SIM and USIM store the International Mobile Subscriber Identity (IMSI) and one or more keys, or shared secrets, for deriving keys used to identify and authenticate subscribers on mobile networks and for services provided by these networks.

Recently, the GSM Association (GSMA) has published specifications for a non-removable UICC, referred to as the embedded UICC or plainly eUICC. The eUICC contains an eSIM application, and the terms non-removable SIM, embedded SIM, and eSIM, are often used synonymously. The eUICC and its embedded SIM have the same functionality as the traditional UICC with its SIM and USIM, but the eUICC has a different form factor and is typically designed to be permanently soldered into a mobile terminal, rather than being removable. The eUICC is a smart card, similar to the UICC, i.e., an electronic device comprising embedded electronic circuits, such as a processor and memory.

By using eUICCs, the mobile terminal may be provisioned for the first time with its first commercial operator (“bootstrapping”), i.e., a Mobile Network Operator (MNO). Over The Air (OTA); that is without physically accessing the mobile terminal, in contrast to today's manually procedure which involves physically swapping the UICC. Other use-cases are, e.g., a “change of operator profile”, i.e., when operator credentials on an eUICC are changed from a current commercial operator to a new commercial operator. As a further example, use-cases may also include “subscription transfer”, i.e., when the operator credentials residing on a current eUICC are transferred to a new eUICC.

To provide mobile connectivity for autonomous vehicles, the manufacturers of the vehicles are expected to use eUICC. This technology defines a chain of trust between several entities that is used to provision the UE with profiles allowing it to connect the mobile networks.

However, the standard eUICC provisioning architecture does not consider the specificities of the autonomous vehicle ecosystem. When provisioning an eUICC with a profile, only the requirements of the telecom ecosystem are considered, while regulations pertaining to the autonomous vehicle ecosystem are disregarded.

### SUMMARY

An object of the present invention is to solve, or at least mitigate, this problem and thus to provide an improved method of provisioning an eUICC of a device with a profile.

This object is attained in a first aspect of the invention by a method of a device manufacturer of registering an eUICC for a device. The method comprises registering an eUICC identifier and a device identifier with a legislation party being responsible for registering ownership of the device, wherein an owner of the device subsequently registers ownership of the device by providing the device identifier to the legislation party along with an owner identifier.

This object is attained in a second aspect of the invention by a manufacturer entity configured to register an eUICC for a device. The entity comprises a processing unit and a memory, said memory containing instructions executable by said processing unit, whereby the entity is operative to register an eUICC identifier and a device identifier with a legislation party being responsible for registering ownership of the device, wherein an owner of the device subsequently registers ownership of the device by providing the device identifier to the legislation party along with an owner identifier.

This object is attained in a third aspect of the invention by a method of an Subscription Manager Secure Routing (SM-SR) entity of controlling eUICC profile provisioning of a device. The method comprises receiving a request to provision the eUICC with a profile, which request comprises an eUICC identifier, verifying, with a legislation party being responsible for registering ownership of the device, that the eUICC identifier previously has been associated with a device identifier and that an ownership has been registered for the identified device, and if the verification is successful provisioning the eUICC of the device with the requested profile.

This object is attained in a fourth aspect of the invention by an SM-SR entity configured to control eUICC profile provisioning of a device, the entity comprising a processing unit and a memory, said memory containing instructions executable by said processing unit, whereby the entity is operative to receive a request to provision the eUICC with a profile, which request comprises an eUICC identifier, verify, with a legislation party being responsible for registering ownership of the device, that the eUICC identifier previously has been associated with a device identifier and that an ownership has been registered for the identified device, and if the verification is successful provisioning the eUICC of the device with the requested profile.

Initially, a device owner requests an appropriate to provision a profile to the eUICC of a device of the owner by providing an eUICC identifier (eID) found in the device documentation. The owner can request the MNO to provision an existing profile or to create a new one.

The MNO typically hosts a Subscription Manager Data Preparation (SM-DP) entity responsible for securely encrypting operator credentials ready for OTA installation. The MNO sends a profile installation request to the SM-SR entity which is responsible for downloading the profile to the eUICC.

Before commencing the profile download and installation procedure, the SM-SR entity turns to the authority in order to verify that the device is properly registered; the SM-SR entity queries the authority 15 providing the eID for the eUICC 13.

The authority will use the provided eID to check if that particular eID previously has been registered with the authority. If the authority finds that the eID previously has been registered with the authority and that ownership has been registered for the device, the authority will confirm that the device indeed has been properly registered. Hence, the authority will acquire the data previously registered by the device manufacturer, as well as the data previously registered by the owner.

If the two data sets match each other, it can be concluded there this an ownership identifier registered for this particular eUICC identifier. Finally, in case of successful verification by the authority, the SM-SR entity provisions the eUICC with the requested profile.

In case of unsuccessful verification, the owner is notified that she needs to register the device before it can be used. Advantageously, the device can only be operated if the owner properly has registered the device with an authorized legislation party.

In an embodiment, the manufacturer entity sends a request to the SM-SR entity configured to provision eUICCs of devices for which ownership must have been registered at the legislation party that said SM-SR entity should be responsible for the provisioning, wherein the responsibility is transferred from an SM-SR entity of a manufacturer of the eUICC to said SM-SR entity.

In an embodiment, the eUICC identifier is configured to indicate whether the eUICC to be provisioned is embedded in a device for which ownership must have been registered at the legislation party or not.

In an embodiment, the device is an autonomous vehicle, such as an autonomous car, an unmanned aerial vehicle, or a robot.

Further embodiments will be described in the following.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates registering an eUICC for a device such as an autonomous vehicle according to an embodiment;

FIG. 2 illustrates provisioning an eUICC with a profile according to an embodiment;

FIG. 3 illustrates registering an eUICC for a device such as an autonomous vehicle according to another embodiment;

FIG. 4 illustrates provisioning an eUICC with a profile according to another embodiment;

FIG. 5 illustrates a manufacturer entity according to an embodiment;

FIG. 6 illustrates a manufacturer entity according to a further embodiment;

FIG. 7 illustrates an SM-SR entity according to an embodiment; and

FIG. 8 illustrates an SM-SR entity according to another embodiment.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

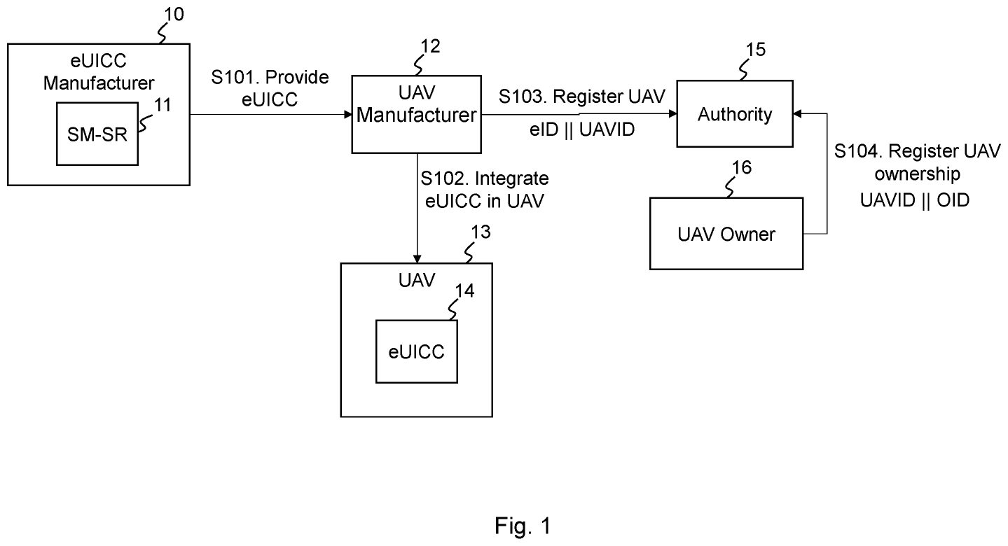

FIG. 1 illustrates an embodiment of registering an eUICC for a device such as an autonomous vehicle. In the following, the device will be exemplified in the form of a UAV.

FIG. 1 shows a system comprising the following entities. An eUICC manufacturer 10 has a key role of manufacturing and distributing eUICCs to be provisioned in wireless communication devices such as smart phone, tablets, laptops, autonomous cars, UAVs, etc.

The eUICC manufacturer 10 typically hosts a Subscription Manager Secure Routing (SM-SR) entity 11 which enables secure download, enablement, disablement and deletion of profiles on the eUICC.

A UAV manufacturer 12 is responsible for manufacturing the UAV 13, and thus for integrating one (or more) eUICCs 14 into the UAV 13.

Further, the system comprises an authority 15, i.e. a legislation party, responsible for registering ownership of the UAV 13 and further being responsible for the legislation regarding UAVs. Its role includes handling the registration of the UAV 13 as well as related owner information. This is required for tracking of the liabilities involving any flying UAV.

The UAV ecosystem also comprises a UAV owner 16 which may be an individual or a company owning the UAV 13.

With further reference to FIG. 1, the process of registering the eUICC 14 for the UAV 13 according to an embodiment is undertaken as follows.

The eUICC manufacturer 10 provides an eUICC 14 to the UAV manufacturer 12 in step S101. It is noted that the eUICC manufacturer 10 may not be aware that the device in which the eUICC 14 is to be provisioned is a UAV 13. Then, in step S102, the UAV manufacturer 12 embeds the eUICC(s) 14 in the UAV 13.

Thereafter, the UAV manufacturer 12 associates an identifier of the UAV 13, referred to as UAVID, with an identifier eID of the eUICC 14 embedded in the UAV 13 and registers the UAVID and the associated eID with the authority 15. For instance, the UAV manufacturer 13 concatenates the two identifiers, resulting in eID∥UAVID.

At this stage, no owner is registered for the UAV, but owner registration is mandatory for the UAV 13 to be allowed to fly.

Hence, in step S104, the owner 16 of the UAV 13 registers her UAV ownership with the authority 15. The UAV 13 is identified by the owner 16 by providing the UAVID to the authority 15. For instance, the UAVID and the eID are noted in documentation associated with the UAV 13. The owner 16 may register her ownership by concatenating an owner identifier OID to the UAVID, and sending the concatenated identifiers—UAVID∥OID—to the authority 15 in step S104.

It is envisaged that the UAV owner 16 may have to verify her identity and possibly also affirm that the UAV 13 has been legitimately acquired, for instance by presenting a receipt.

After this procedure, the owner 16 is properly registered and the UAV 13 is legally allowed to fly (within the framework set by regulations).

In the future, it might become illegal to provide internet connectivity to an autonomous vehicle, such as a UAV, that is not properly registered towards the authorities. However, the currently used eUICC provisioning ecosystem does not consider any UAV specificities and will “blindly”, and possibly illegally, provision a profile to a eUICC in a UAV if the requirements in the telecom space are fulfilled. Advantageously, with this embodiment, the UAV is properly registered with the authorities.

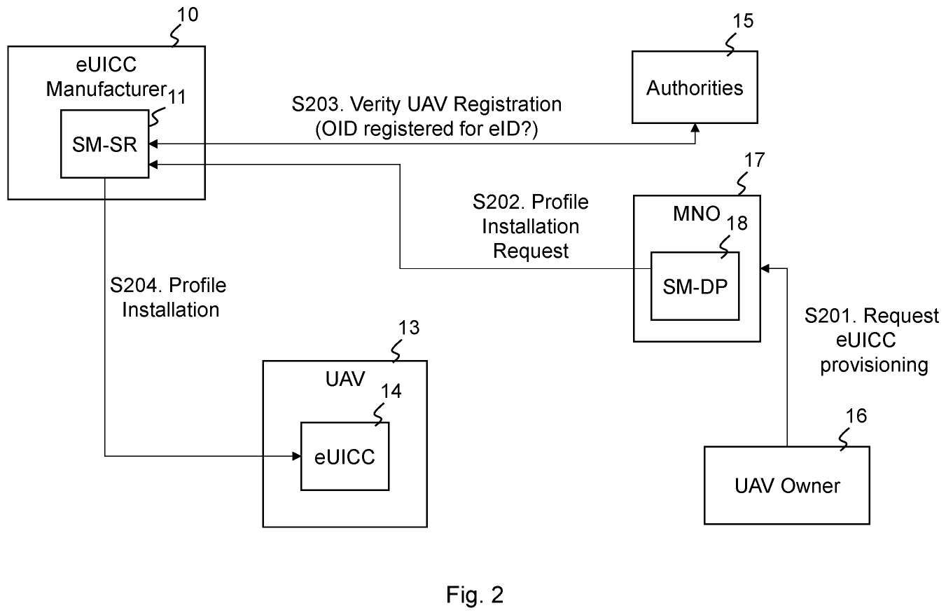

FIG. 2 illustrates provisioning an eUICC with a profile according to an embodiment. A main task of the provisioning of an eUICC with a profile is to download a so called Issuer Security Domain Profile (ISD-P) representing a particular MNO to the eUICC.

In a first step S201, the UAV owner 16 requests an appropriate MNO 17 to provision a profile to the eUICC 14 of her UAV 13 by providing the eID found in the UAV documentation. The owner 16 can request the MNO 17 to provision an existing profile or to create a new one.

The MNO 17 typically hosts a Subscription Manager Data Preparation (SM-DP) entity 18 responsible for securely encrypting operator credentials ready for OTA installation. If the MNO 17 needs to create a new profile, it orders one from the SM-DP entity 18. It is noted that the profile need not contain any indication that it is to be used by a UAV, even though the MNO 17 may include such an indication.

The MNO 17 sends a profile installation request in step S202 to the SM-SR entity 11 which is responsible for downloading the profile to the eUICC 14.

Before commencing the profile download and installation procedure, the SM-SR entity 11 turns to the authority 15 in step S203 in order to verify that the UAV is properly registered. Hence, the SM-SR entity 11 queries the authority 15 by providing the eID for the eUICC 13.

The authority 15 will thus use the provided eID to check if that particular eID previously has been registered with the authority 15. If the authority 15 finds that the eID previously has been registered with the authority 15 and that ownership has been registered for the device (the device being identified at the authority by means of the UAVID associated with the eID), the authority will confirm that the UAV 13 indeed has been properly registered. Hence, the authority 15 will acquire the data previously registered by the UAV manufacturer 13 in step S103, eID∥UAVID, as well as the data previously registered by the owner 16 in step S104, UAVID∥OID.

If the UAVIDs of the two sets match each other, it can be concluded there this an ownership identifier OID registered for this particular eUICC identifier.

Finally, in case of successful verification by the authority 15 in step S203, the SM-SR entity 11 provisions the eUICC 14 with the requested profile in step S204. It is noted that the provisioning may include profile enabling in case an existing profile already is preloaded into the eUICC 14 during manufacturing, and a new profile provisioned in step S204 is to be used.

In case of unsuccessful verification, the owner 16 is notified that she needs to register the UAV 13 before it can be used. Advantageously, the UAV 13 can only be operated if the owner 16 properly has registered the UAV 13 with an authorized legislation party 15.

Again with reference to FIGS. 1 and 2, in an embodiment, the SM-SR entity 11 may handle provisioning of a variety of different-type devices, ranging from ordinary smart phones to UAVs. Hence, upon receiving the profile installation request in step S202, it may not be aware of whether the eUICC 14 to be provisioned is embedded in a device for which ownership must have been registered at an appropriate legislation party or not. Typically, for a device such as a smart phone, a tablet or a smart watch, there is no need to turn to a legislation party 15 when performing the provisioning.

To avoid this potential problem, the eUICC manufacturer 11 may configure the eUICC eIDs such that an eID indicates that an associated eUICC to be provisioned is embedded in a device for which ownership must have been registered at an appropriate legislation party for the provisioning to be possible. For instance, this may be effect by encoding the eID with a particular bit pattern.

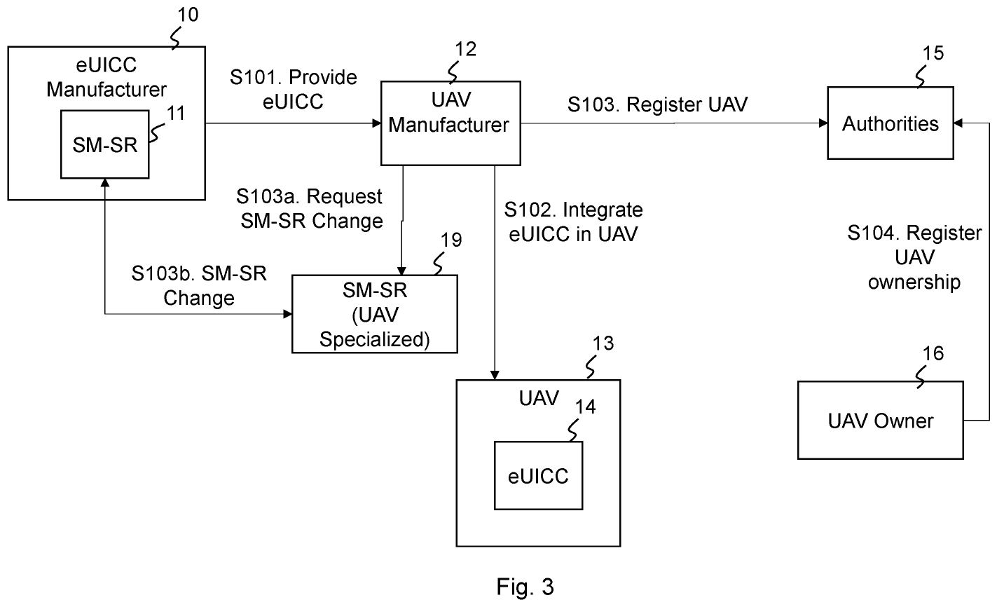

FIG. 3 illustrates an alternative embodiment of registering an eUICC for a device.

In addition to the entities illustrated with reference to the FIG. 1, the system 10 comprises a further SM-SR 19 being specialized for devices (in this example a UAV) for which ownership must have been registered at an appropriate legislation party.

The rationale for introducing the UAV-specialized SM-SR entity 19 is that the “ordinary” SM-SR entity 11 hosted by the eUICC manufacturer 11 may not be capable of performing the eUICC provisioning procedure, described e.g. in GSMA document “Embedded SIM Remote Provisioning Architecture”, Version 1.1, 17 Dec. 2013, in particular if UAV-specific steps are to be included in the provisioning procedure.

The UAV manufacturer 12 will some time during the registration process, such as after the UAV 13 has been registered with the authority 15 in step S103, send a request to the UAV-specialized SM-SR entity 19 for SM-SR change, as illustrated in step S103a.

Hence, the UAV-specialized SM-SR entity 19 turns to the SM-SR entity 11 of the eUICC manufacturer 10 which transfers the responsibility to the UAV-specialized SM-SR entity 19 to handle eUICC provisioning in step S103b. Hence, after step S103b is performed, it is generally no longer possible for the SM-SR entity 11 of the eUICC manufacturer 10 to perform any actions for the eUICC 14.

The ownership is registered with the authority 15 in step S104 as previously described.

It is noted that the SM-SR entity 11 of the eUICC manufacturer 10 may turn to the authority 15 for checking that ownership has been properly registered for the UAV 12 before the SM-SR change is performed. If so, step S103b would occur after steps S103 and S104 have been performed, where the UAV 13 and the ownership are registered with the authority 15. Advantageously, this would protect against a malicious party attempting to bypass the check by changing the SM-SR to one not enforcing the UAV regulation.

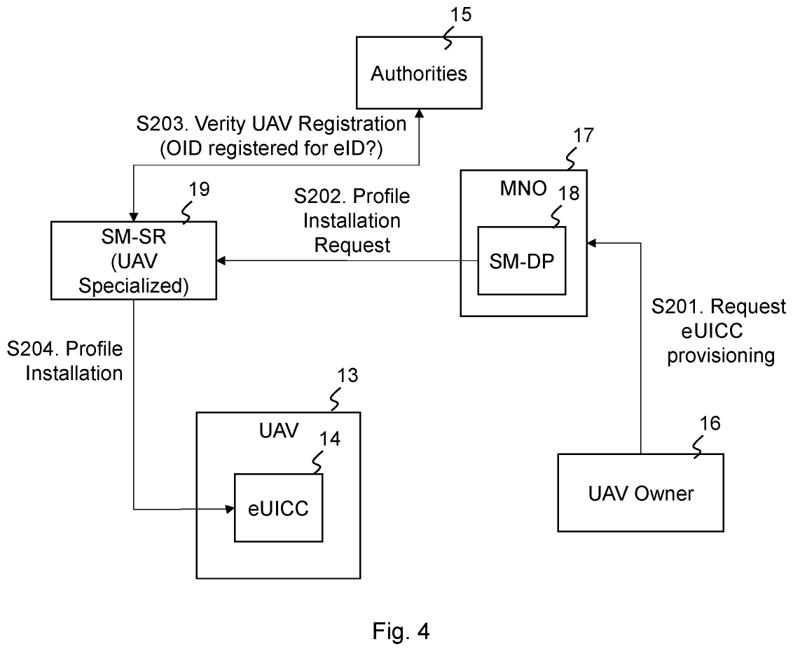

FIG. 4 illustrates provisioning an eUICC with a profile according to another embodiment. This embodiment illustrates provisioning where the UAV-specialized SM-SR entity 19 described with reference to FIG. 3 is introduced

In a first step S201, the UAV owner 16 requests an appropriate MNO 17 to provision a profile to the eUICC 14 of her UAV 13 by providing the eID found in the UAV documentation.

The MNO 17 sends a profile installation request in step S202 to the UAV-specialized SM-SR entity 19 which is responsible for downloading the profile to the eUICC 14.

Hence, in contrast to the provision procedure described with reference to FIG. 2, the UAV-specialized SM SR entity 19 will provision the eUICC 14, and there is no need to involve the SM-SR entity 12 of the eUICC manufacturer 11.

Before commencing the profile download and installation procedure, the UAV-specialized SM SR entity 19 turns to the authority 15 in step S203 in order to verify that the UAV is properly registered. Hence, the UAV-specialized SM SR entity 19 queries the authority 15 by providing the eID for the eUICC 13.

The authority 15 will thus use the provided eID to check if that particular eID previously has been registered with the authority 15. If the authority 15 finds that the eID previously has been registered with the authority 15 (in step S103 of FIG. 1) and that ownership has been registered for the device (the device being identified at the authority by means of the UAVID associated with the eID), the authority will confirm that the UAV 13 indeed has been properly registered.

Finally, in case of successful verification by the authority 15 in step S203, the UAV-specialized SM SR entity 19 provisions the eUICC 14 with the requested profile in step S204. Again, the provisioning may include profile enabling in case an existing profile already is preloaded into the eUICC 14 during manufacturing, and a new profile provisioned in step S204 is to be used.

As can be concluded from above, with embodiments described herein, the standard eUICC ecosystem is augmented to integrate the autonomous device use-case specificities. An SM-SR entity of a eUICC manufacturer, or a specialized SM-SR to which the provisioning task is transferred, is configured to check for proper registration of an autonomous device before provisioning the eUICC(s) embedded in the device. Any device that is not properly registered would not be able to obtain mobile network connectivity, and thus could not be operated.

Advantageously, the proposed solution increases the safety of the provisioning of an autonomous device with mobile connectivity. It allows the enforcement of proper registration of the device before allowing anyone —even a rogue MNO—to provision its eUICC(s) with profiles.

This solution leverages the standard eUICC ecosystem. This allows the system to benefit from the chain of trust which is built, providing security along the lifecycle of the device.

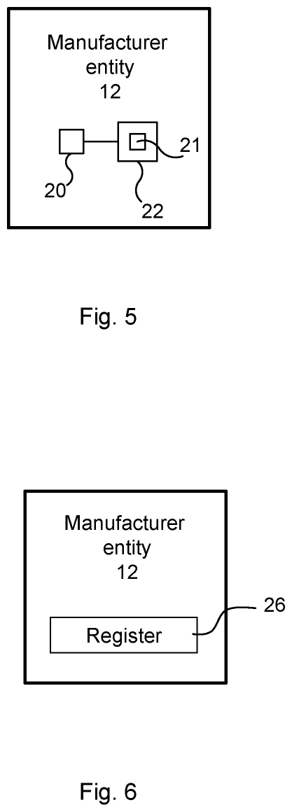

FIG. 5 illustrates a manufacturer entity 12 according to an embodiment. The steps of the method performed by the manufacturer entity 12, being embodied e.g. in the form of a computer, of registering an eUICC for a device according to embodiments are in practice performed by a processing unit 20 embodied in the form of one or more microprocessors arranged to execute a computer program 21 downloaded to a suitable storage volatile medium 22 associated with the microprocessor, such as a Random Access Memory (RAM), or a non-volatile storage medium such as a Flash memory or a hard disk drive. The processing unit 20 is arranged to cause the entity 12 to carry out the method according to embodiments when the appropriate computer program 21 comprising computer-executable instructions is downloaded to the storage medium 22 and executed by the processing unit 20. The storage medium 22 may also be a computer program product comprising the computer program 21. Alternatively, the computer program 21 may be transferred to the storage medium 22 by means of a suitable computer program product, such as a Digital Versatile Disc (DVD) or a memory stick. As a further alternative, the computer program 21 may be downloaded to the storage medium 22 over a network. The processing unit 20 may alternatively be embodied in the form of a digital signal processor (DSP), an application specific integrated circuit (ASIC), a field-programmable gate array (FPGA), a complex programmable logic device (CPLD), etc.

FIG. 6 illustrates a manufacturer entity 12 according to a further embodiment. The manufacturer entity 12 comprises registering means 26 adapted to register an eUICC identifier and a device identifier with a legislation party being responsible for registering ownership of the device, wherein an owner of the device subsequently registers ownership of the device by providing the device identifier to the legislation party along with an owner identifier.

The registering means 26 may comprise communication interface(s) for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

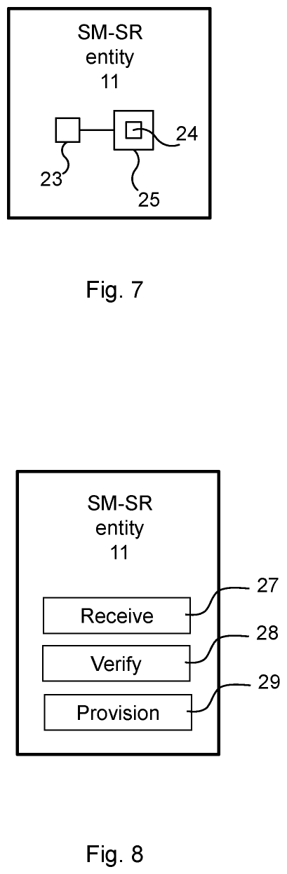

FIG. 7 illustrates an SM-SR entity 11 according to an embodiment. The steps of the method performed by the SM-SR entity 11, being embodied e.g. in the form of a computer, of controlling eUICC profile provisioning of a device according to embodiments are in practice performed by a processing unit 23 embodied in the form of one or more microprocessors arranged to execute a computer program 24 downloaded to a suitable storage volatile medium 25 associated with the microprocessor, such as a RAM, or a non-volatile storage medium such as a Flash memory or a hard disk drive. The processing unit 23 is arranged to cause the SM-SR entity 11 to carry out the method according to embodiments when the appropriate computer program 24 comprising computer-executable instructions is downloaded to the storage medium 25 and executed by the processing unit 23. The storage medium 25 may also be a computer program product comprising the computer program 24. Alternatively, the computer program 24 may be transferred to the storage medium 25 by means of a suitable computer program product, such as a DVD or a memory stick. As a further alternative, the computer program 24 may be downloaded to the storage medium 25 over a network. The processing unit 23 may alternatively be embodied in the form of a DSP, an ASIC, an FPGA, a CPLD, etc.

FIG. 8 illustrates an SM-SR entity 11 according to another embodiment. The SM-SR entity 11 comprises receiving means 27 adapted to receive a request to provision the eUICC with a profile, which request comprises an eUICC identifier, verifying means 28 adapted to verify, with a legislation party being responsible for registering ownership of the device, that the eUICC identifier previously has been associated with a device identifier and that an ownership has been registered for the identified device, and provisioning means 29 adapted to, if the verification is successful, provision the eUICC of the device with the requested profile.

The means 27-29 may comprise communication interface(s) for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

The invention has mainly been described above with reference to a few embodiments. However, as is readily appreciated by a person skilled in the art, other embodiments than the ones disclosed above are equally possible within the scope of the invention, as defined by the appended patent claims.

1. A method of a device manufacturer of registering an embedded Universal Integrated Circuit Card (eUICC) for a device comprising:
registering an eUICC identifier and a device identifier with a registering authority being responsible for registering ownership of the device, wherein an owner of the device subsequently registers ownership of the device by providing the device identifier to the registering authority along with an owner identifier.

2. The method of claim 1, further comprising:
sending a request to a Subscription Manager Secure Routing (SM-SR) entity configured to provision eUICCs of devices for which ownership must have been registered at the registering authority that said SM-SR entity should be responsible for the provisioning, wherein responsibility is transferred from an SM-SR entity of a manufacturer of the eUICC to said SM-SR entity.

3. The method of claim 1, wherein the eUICC identifier is configured to indicate whether the eUICC to be provisioned is embedded in the device for which ownership must have been registered at the registering authority.

4. The method of claim 1, wherein the device being an autonomous vehicle, an unmanned aerial vehicle, or a robot.

5. A method of a Subscription Manager Secure Routing (SM-SR) entity of controlling embedded Universal Integrated Circuit Card (eUICC) profile provisioning of a device comprising:
receiving a request to provision the eUICC with a profile, which request comprises an eUICC identifier;
verifying, with a registering authority being responsible for registering ownership of the device, that the eUICC identifier previously has been associated with a device identifier and that an ownership has been registered for the identified device; and
in response to a verification being successful, provisioning the eUICC of the device with the requested profile.

6. The method of claim 5, wherein the eUICC identifier is configured to indicate whether the eUICC to be provisioned is embedded in the device for which ownership must have been registered at the registering authority.

7. The method of claim 5, wherein the SM-SR entity is configured to be an SM-SR entity of a manufacturer of the eUICC.

8. The method of claim 5, wherein the SM-SR entity is configured to be an SM-SR entity configured to provision eUICCs of devices for which ownership must have been registered at the registering authority, a responsibility of provisioning having been transferred from an SM-SR entity of a manufacturer of the eUICC to said SM-SR entity.

9. An apparatus of a manufacturer entity configured to register an embedded Universal Integrated Circuit Card (eUICC) for a device, the apparatus comprising:
a processing unit; and
a memory, said memory containing instructions which, when executed by said processing unit, cause the apparatus to:
register an eUICC identifier and a device identifier with a registering authority being responsible for registering ownership of the device, wherein an owner of the device subsequently registers ownership of the device by providing the device identifier to the registering authority along with an owner identifier.

10. The apparatus of claim 9, further to:
send a request to a Subscription Manager Secure Routing (SM-SR) entity configured to provision eUICCs of devices for which ownership must have been registered at the registering authority that said SM-SR entity should be responsible for the provisioning, wherein responsibility is transferred from an SM-SR entity of a manufacturer of the eUICC to said SM-SR entity.

11. The apparatus of claim 9, wherein the eUICC identifier is configured to indicate whether the eUICC to be provisioned is embedded in the device for which ownership must have been registered at the registering authority.

12. The apparatus of claim 9, wherein the device being an autonomous vehicle, an unmanned aerial vehicle, or a robot.

13. An apparatus of a Subscription Manager Secure Routing (SM-SR) entity configured to control embedded Universal Integrated Circuit Card (eUICC) profile provisioning of a device, the apparatus comprising:
a processing unit and
a memory, said memory containing instructions which, when executed by said processing unit, cause the apparatus to:
receive a request to provision the eUICC with a profile, which request comprises an eUICC identifier;
verify, with a registering authority being responsible for registering ownership of the device, that the eUICC identifier previously has been associated with a device identifier and that an ownership has been registered for the identified device; and
in response to a verification being successful, provisioning the eUICC of the device with the requested profile.

14. The apparatus of claim 13, wherein the eUICC identifier is configured to indicate whether the eUICC to be provisioned is embedded in the device for which ownership must have been registered at the registering authority.

15. The apparatus of claim 13, wherein the SM-SR entity is configured to be an SM-SR entity of a manufacturer of the eUICC.

16. The apparatus of claim 13, wherein the SM-SR entity is configured to be an SM-SR entity configured to provision eUICCs of devices for which ownership must have been registered at the registering authority, a responsibility of provisioning having been transferred from an SM-SR entity of a manufacturer of the eUICC to said SM-SR entity.

17-20. (canceled)
